(19) United States
(12) Patent Application Publication
(10) Pub. No.: US 2021/0206090 A1
(43) Pub. Date: Jul. 8, 2021

(54) SERVICE MODULE OF A THREE-DIMENSIONAL (3D) PRINTER

(71) Applicant: HEWLETT-PACKARD DEVELOPMENT COMPANY, L.P., Spring, TX (US)

(72) Inventors: Warren Scott MARTIN, Vancouver, WA (US); Miquel ALVAREZ, Vancouver, WA (US); Michael GRAHAM, (US)

(73) Assignee: HEWLETT-PACKARD DEVELOPMENT COMPANY, L.P., Houston, TX (US)

(21) Appl. No.: 16/074,818

(22) PCT Filed: Apr. 21, 2017
(86) PCT No.: PCT/US2017/028843

§ 371 Date: Aug. 2, 2018

(51) Int. Cl. B29C 64/35; B29C 64/112

(52) U.S. Cl. CPC B29C 64/35; B33Y 30/00; B29C 64/112

(57) ABSTRACT

In some examples, a service module of a three-dimensional (3D) printer can include a modular web to removably couple to the service module of the 3D printer and when coupled to the service module can clean a print head of the 3D printer and remove a printing agent from the print head.

### BACKGROUND

A three dimensional (30) printer may be used to create different 3D objects. 3D objects created by a 3D printer may be used for various purposes. For example, 3D objects may be used for prototyping, testing, and/or used for other commercial uses.

In some examples, 3D printers may utilize an additive manufacturing process. For instance, a 3D printer may deposit material in successive layers to create a 3D object. The material can be solidified to form the successive layers of the 3D object.

### BRIEF DESCRIPTION OF THE DRAWINGS

FIG. 1 illustrates a diagram of an example of a 3D printer including service module and a print head consistent with the disclosure.

FIG. 2A illustrates a diagram of an example of a service module of a 3D printer consistent with the disclosure.

FIG. 2B illustrates a diagram of an example of a service module of a 3D printer consistent with the disclosure.

FIG. 3 illustrates a diagram of an example of an aerosol collection module of a service module of a 3D printer consistent with the disclosure.

FIG. 4 illustrates an example of a method to clean a print head of a service module of a 3D printer and remove a printing agent consistent with the disclosure.

FIG. 5 illustrates a diagram of an example of a method consistent with the disclosure.

### DETAILED DESCRIPTION

A 3D printer may utilize a service module before, during, or after creating a 3D object. A 3D printer may apply print media such as a build material, and/or printing agents such as fusing agents, and/or cosmetic agents to the 3D object during the print operation of the 3D object. The components delivering the printing and media agents may have to be kept clean to ensure efficient and/or proper functioning of the components of the 3D printer. As used here, the term “print operation” can, for example, refer to a process of creating a 3D object and may be performed, for example, by a 3D printer.

As used herein, the term “3D printer” can, for example, refer to a device that can create a physical 3D object. In some examples, the 3D printer can create the 3D object utilizing a 3D digital model. The 3D printer can create the 3D object by, for example, depositing a printing media such as a build material, and a printing agent. The build material and printing agent may be deposited in successive layers to create the 3D object. In some examples, a 3D printer can create the 3D object utilizing powder bed fusion, among other types of 3D printing.

The components delivering the printing and media agents may be cleaned using a service module. In some examples, a service module of a three-dimensional (3D) printer can include a modular web to removably couple to the service module of the 3D printer and when coupled to the service module can clean a print head of the 3D printer and remove a printing agent from the print head.

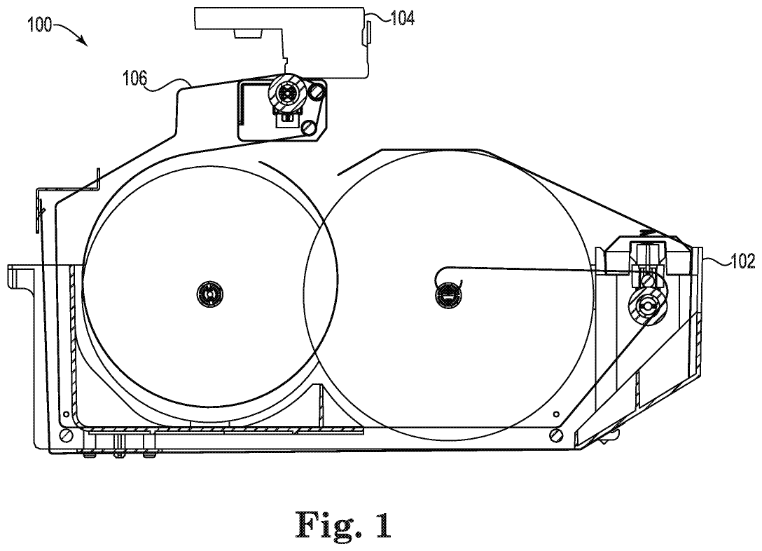

FIG. 1 illustrates a diagram of an example of a 3D printer including a service module and a print head consistent with the disclosure. The 3D printer 100 can include a service module 102 and a print head 104. The print head 104 can be included in a print bar, not shown. As used herein, the term “print head” can, for example, refer to a mechanism included in the 3D printer 100, where the print head 104 can deposit printing agents by, for example, using nozzles. The print head may deliver printing agents including liquid agents, such as liquid agents used for fusing powdered plastic, colorants, cooling agents, and/or cosmetic enhancers.

The printing agent may interact with a print media, such as a build material, to produce various desired material properties for a particular print operation of a 3D printing process. In some examples, the build material can be powder. As used herein, the term “build material” can, for example, refer to a powdered material which may be layered and bound via a printing agent during a print job of a 3D printing process. The powdered material can be, for example, a powdered semi-crystalline thermoplastic material, a powdered metal material, a powdered plastic material, a powdered composite material, a powdered ceramic material, a powdered glass material, a powdered resin material, and/or a powdered polymer material, among other types of powdered material.

The service module 102 can include a removably coupled modular web 106. Modular web 106 can be used to clean a print head 104 of the 3D printer 100. As used herein, the term “modular web” can, for example, refer to a material used to wipe a print head 104. Modular web 106 can be, for example, cotton, foam, microdenier, nonwoven, nylon, and/or polyester, material, among other types of lint-free materials.

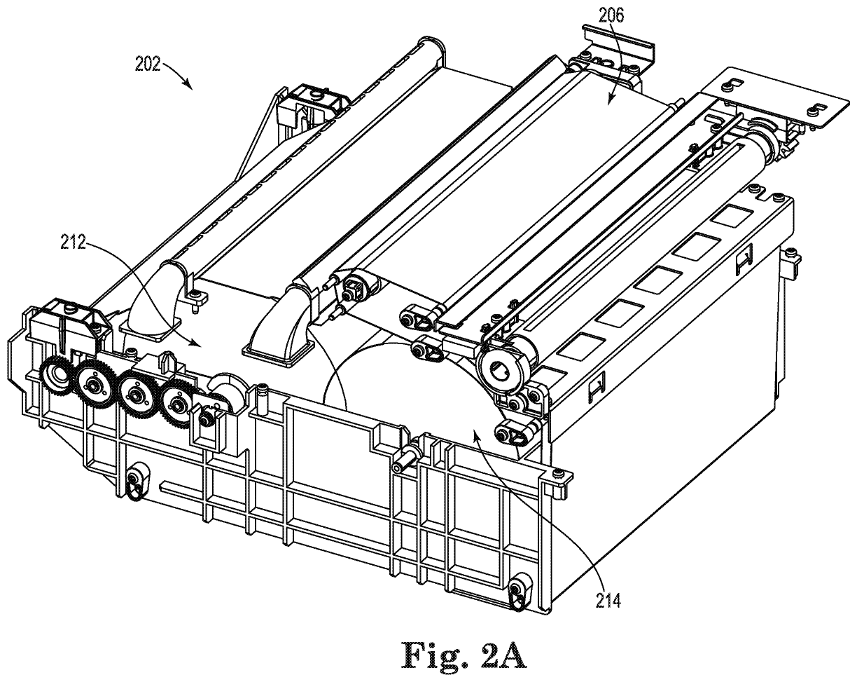

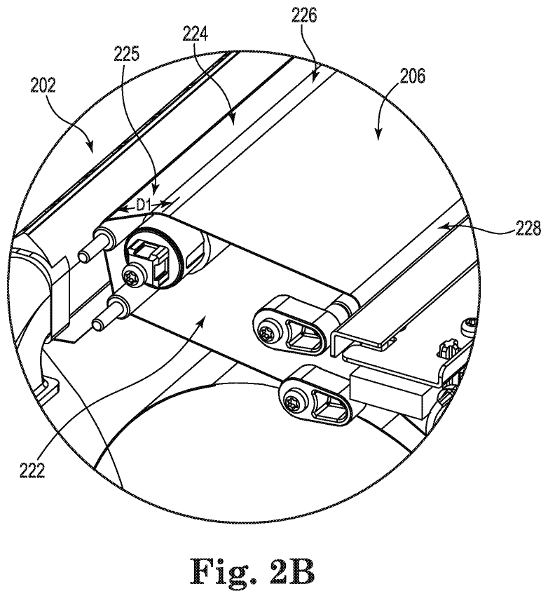

As shown in FIG. 1, a modular web 106 can be removably coupled to the print head 104. The modular web 106 can clean the print head 104 and remove printing agent from the print head 104 when the modular web 106 is coupled to the print head 104. The modular web 106 may be advanced through the service module 102 such that unused web, e.g. clean web, from the modular web 106 can be presented to clean print head 104. Cleaning, e.g. wiping, the print head 104 can be achieved by advancing the modular web 106 to a wiping location (e.g. wiping location 226, described in connection with FIG. 2B, respectively) in contact with the print head 104. The carriage attached to the print head 104 can move the print head 104 along the modular web 106 to clean the print head 104. For example, the modular web 106 can remove residual agents and powder debris from the nozzle surface of the print head 104. In some examples, the modular web 106 can be used to clean the print head 104 when the print head 104 is inactive, e.g. not performing a print operation.

As used herein, “inactive” refers to a state when the print head is not laying down printing agent to create a 3D object. Cleaning the print head 104 can include wiping a nozzle of the print head 104 on the modular web 106. Similarly, when the print head 104 is inactive, the modular web 106 can be used to remove the printing agent.

Removing the printing agent can include purging the printing agent from the print head 104 onto the modular web 106. The printing agent can be removed from the print head 104 via the nozzle of the print head 104. Purging may be done to maintain the nozzle of the print head 104.

In some examples, the 3D printer 100 does not include a spittoon. That is, in contrast to some approaches which may employ a spittoon or other receptacle having an internal volume greater than an internal volume of the print head 104, the 3D printer 100 herein can desirably have a smaller overall footprint and/or employ fewer components due to the service module 102 removal of the printing agent via the modular web 106.

FIG. 2A illustrates a diagram of an example of a service module of a 3D printer consistent with the disclosure. The service module 202 can include a first roll 214 of modular web 206 and a second roll 212 of modular web 206. The first roll 214 may be used to store clean modular web 206 and the second roll 212 may be used to store dirty modular web 206.

In some examples, the modular web 206 may have a length greater than 4 meters. For example, the modular web 206 may have a length in a range from 50 meters to 4.1 meters. All subranges and values from 50 meters to 4.1 meters are included in the range. For example, the modular web 205 can be from an upper limit of 50 meters, 40 meters, or 30 meters to a lower limit of 20 meters, 10 meters, or 4.1 meters, among other possible values.

The length of the modular web 206 may depend on the amount of printing agent that can be removed from the print head (e.g. print head 104, described in connection with FIG. 1) since the modular web 206 is used to clean and collect printing agent. The length of the modular web 206 may also depend on how often the modular web 206 may be replaced.

For instance, a modular web 206 that is 50 meters long, for example, may be used for 6 months before being replaced. While a modular web 206 that is half that length may be replaced in 3 months. The length of the modular web 206 may also depend on the desired footprint of the 3D printer (e.g. 3D printer 100, described in connection with FIG. 1. The modular web 206 of a 3D printer with a small footprint may have less length than a 3D printer with a larger footprint due to size limitations.

As shown in FIG. 2A, the first roll 214 can unwind and advance the modular web 206 through the service module 202 to cause the modular web 206 to wipe the print head. The portion of the modular web 206 that has wiped the print head can be advanced through the service module 202 to receive printing agent purged from the print head.

The portion of the modular web 206 that has wiped the print head (and has received printing agent from the print head can be advanced through the service module 202 and wound onto the second roll 212. That is, the first roll 214 of the modular web 206 can be clean modular web 206 unwound and advanced to wipe the print head.

After wiping the print head modular web 206 can include powder deposits and can be referred to as dirty modular web 206. The dirty modular web 206 can then be used to receive printing agent from the print head and following receiving printing agent can be wound onto the second roll 212 of the modular web 206.

FIG. 2B illustrates a diagram of an example of a service module of a 3D printer consistent with the disclosure. As illustrated in FIG. 2, the service module 202 can include a modular web 206. The modular web 206 can include a wiping location 226 and a spitting location 228. The modular web 206 can also include a first side 222 of the modular web 206 and a second side 224 of the modular web 206. The second side 224 of the modular web 206 can include an exposed distance 225.

As used herein, the term “exposed” can, for example, refer to a side of the modular web 206 orientated such that printing and media agents and/or airborne printing and media agents can contact or otherwise collect on the exposed side of the modular web 206 before the modular web 206 advances to wipe the print head (e.g. print head 104, described in connection with FIG. 1).

In some examples, the first side 222 of the modular web 206 may be exposed as the modular web 206 unwinds and advances from the first roll 214 of the modular web 206. In some examples, the second side 212 of the modular web 206 may not be exposed as the modular web 206 unwinds and advances from the first roll 214 of the modular web 206. In some examples, the print head may be cleaned by the exposed second side 224 of the modular web 206. Cleaning the print head can include wiping a nozzle of the print head on the exposed second side 224 of the modular web 206.

As shown in FIG. 2B, the first side 222 of the modular web 206 can be removed from the first roll 214 and travel a distance, after which the first side 222 is flipped exposing the second side 224 for cleaning the print head (e.g. print head 104, described in connection with FIG. 1). As shown in FIG. 2B, the first side 222 of the modular web 206 and the second side 224 of the modular web 206 can be exposed to printing and media agents and airborne printing and media agents as the modular web 206 advances to the wiping location 226. However, the second side 224 of the modular web 206 has less distance to travel to the wiping location 226 and as a result can contact and/or collect less printing and media agents and airborne printing and media agents than the first side 222. In some examples, by flipping the modular web 206 from a first side 222 to a second side 224, the exposed distance 225, of the second side 224 of the modular web 206, to printing and media agents and airborne printing and media agents is minimized as the modular web 206 advances to the wiping location 226.

In some examples, the exposed distance of the second side 224 can be 22 millimeters (mm) or less. For example, the exposed distance of the second side 224 can be in a range from 22 mm to 0.1 mm. All subranges and values from 22 mm to 0.1 mm are included in the range. For example, the exposed distance of the second side 224 can be from an upper limit of 22 mm, 20 mm, or 16 mm to a lower limit of 10 mm, 2 mm, or 0.1 mm, among other possible values.

As shown in FIG. 2B, the modular web 206 can include a wiping location 226 and a spitting location 228. In the wiping location 226, nozzles of the print head (e.g. print head 104, described in connection with FIG. 1, respectively) may be wiped across the modular web 206. The modular web 206 can advance from the wiping location 226 to the spitting location 228.

In some examples, the print head can purge printing agent in the spitting location 228 and the modular web 206 can store the printing agent. For instance, when the print head is not laying down printing agent, e.g. inactive, the nozzles may be maintained by causing the nozzles to deposit print media onto the modular web 206.

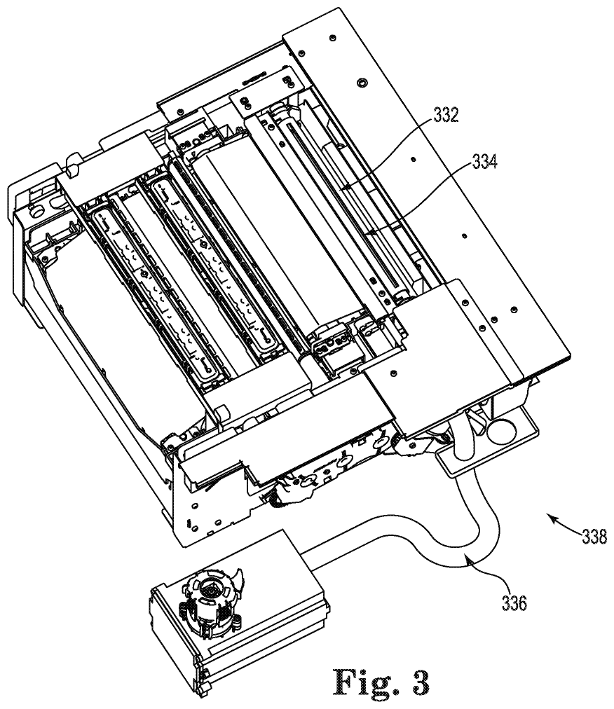

FIG. 3 illustrates a diagram of an example of an aerosol collection module of a service module of a 3D printer consistent with the disclosure. The aerosol collection module 338 can include a spit roller 332 and a vacuum 336. The spit roller 332 can have an opening 334.

As shown in FIG. 3, the opening 334 can allow the spit roller 332 to receive airborne printing and media agents. In some examples, the vacuum 336 can be connected to the spit roller 332 and can include a filter. The vacuum 336 can remove the airborne printing and media agents from the service module (e.g. service module 102, 202, described in connection with FIGS. 1, 2A, and 28, respectively) and/or the 3D printer (e.g. 3D printer 100, described in connection with FIG. 1). Removing the airborne printing and media agents from the service module and/or the 3D printer can prevent components from becoming dirty and ruining a 3D object.

For example, the aerosol collection module 338 can prevent clean modular web (e.g. modular web 106, 206, described in connection with FIGS. 1, 2A, and 2B, respectively) from contacting and collecting airborne printing and media agents by removing airborne printing and media agents from the service module and/or the 3D printer. This can prevent the nozzles of the print head (e.g. print head 104, described in connection with FIG. 1, respectively) from wiping on a dirty modular web.

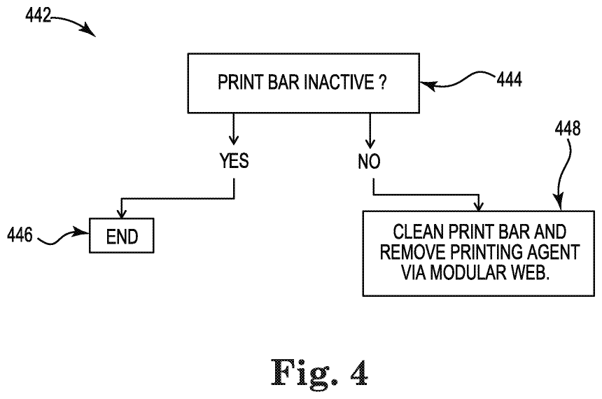

FIG. 4 illustrates an example of a method to clean a print head of a service module of a 3D printer and remove a printing agent consistent with the disclosure. For example, the method 442 can be performed by a service module (e.g. service module 102, 202, described in connection with FIGS. 1, 2A, and 2B, respectively) to clean a print head (e.g. print head 104, described in connection with FIG. 1, respectively) and remove printing agent.

At 444, the method 442 includes the service module detecting whether the printer is laying down printing agent. If the service module detects that the print head is laying down printing agent then the method 442 ends 446.

If the service module detects that the print head is not laying down printing agent then the method 442 continues and the service module cleans the print head of the service module of the 3D printer (e.g. 3D printer 100, described in connection with FIG. 1) via a modular web and removes printing agent via the modular web.

In some examples, at 448 of the method 442, cleaning the print head can include unwinding the modular web from a first roll (e.g. first roll 214, described in connection with FIG. 2A, respectively) and in some examples removing the printing agent includes winding the modular web on to a second roll (e.g. second roll 212, described in connection with FIG. 2A, respectively).

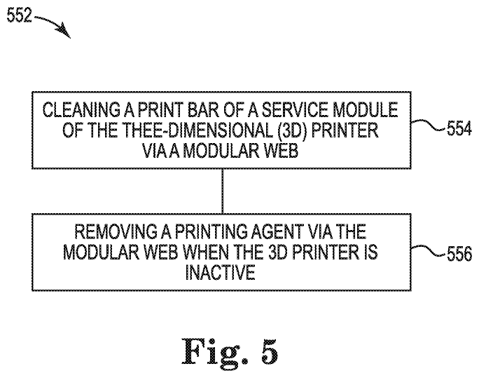

FIG. 5 illustrates a diagram of an example of a method 552 consistent with the disclosure. As illustrated at 554, the method 552 can include cleaning a print head of a service module of the 3D printer via a modular web. As mentioned cleaning the print head can include wiping a nozzle of the print head on the modular web. In various examples, the method can include cleaning the print head when the 3D printer is inactive.

As illustrated at 556, the method 552 can include removing a printing agent via the modular web when the 3D printer is inactive. As mentioned, removing the printing agent can include purging the printing agent from the print head onto the modular web, in contrast to other approaches which may rely on a comparatively large spittoon or other large walled receptacle to purge a liquid from a 3D printer.

The figures follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

The above specification, examples and data provide a description of the method and applications, and use of the system and method of the disclosure. Since many examples may be made without departing from the spirit and scope of the system of the disclosure, this specification merely sets forth some of the many possible example configurations and implementations.

What is claimed is:

1. A service module of a three-dimensional (3D) printer, comprising:
a modular web to removably couple to the service module of the 3D printer and when coupled to the service module to:
clean a print head of the 3D printer; and
remove a printing agent from the print head.

2. The service module of claim 1, wherein the service module does not include a spittoon.

3. The service module of claim 1, wherein the service module includes a spit roller to receive airborne printing and media agents.

4. The service module of claim 1, wherein a length of the modular web is greater than 4 meters.

5. The service module of claim 1, wherein the modular web is to clean the print head and to remove the printing agent when the print head is inactive.

6. The service module of claim 1, wherein a first side of the modular web is exposed to printing and media agents as the modular web unwinds and advances from a first roll.

7. The service module of claim 1, wherein the second side of the modular web contacts the print head to clean the print head.

8. The service module of claim 7, wherein the second side of the modular web is exposed for 22 millimeters or less before the print head is cleaned.

9. An aerosol collection module of a service module of a three-dimensional (3D) printer, comprising:
a spit roller of the service module of the 3D printer with an opening to receive airborne printing and media agents; and
a vacuum connected to the spit roller to remove the airborne printing and media agents.

10. The aerosol module of claim 9, wherein the vacuum includes a filter.

11. A method, comprising:
cleaning a print head of a service module of the three-dimensional (3D) printer via a modular web; and
removing a printing agent via the modular web when the 3D printer is inactive.

12. The method of claim 11, wherein cleaning the print head includes wiping a nozzle of a print head on the modular web.

13. The method of claim 11, wherein removing the printing agent includes purging the printing agent from the print head onto the modular web.

14. The method of claim 11, wherein cleaning the print head includes unwinding the modular web from a first roll and winding the modular web onto a second roller.

15. The method of claim 14, wherein the first roll stores clean modular web and the second roll stores dirty modular web.
